(19) United States
(12) Patent Application Publication
(10) Pub. No.: US 2009/0322771 A1
(43) Pub. Date: Dec. 31, 2009

(54) Method for providing multiple users with private access to a computer

(76) Inventors: Eldad Eilam, Tel-Aviv (IL); Yonatan Doron, Tel-Aviv (IL); Russ Osterlund, Merrimack, NH (US); David Sleeper, Meredith, NH (US)

Correspondence Address: LAW OFFICES OF TIMOTHY BRISSON, 340 GRASS VALLEY HIGHWAY, AUBURN, CA, 95603, US

(21) Appl. No.: 12/404,167

(22) Filed: Mar. 13, 2009

Related U.S. Application Data
(60) Provisional application No. 61/069,652, filed on Mar. 13, 2008.

(51) Int. Cl. G06F 12/02

(52) U.S. Cl. 345/543

(57) ABSTRACT

This disclosure describes a method for allowing multiple users to independently run graphical applications on a Windows computer at the same time by loading private instances of the graphics subsystem for each user at different virtual addresses within the kernel address space.

### CROSS-REFERENCE TO RELATED APPLICATIONS

This application claims priority to U.S. Provisional Application 61/069,652, filed Mar. 13, 2008, which is incorporated by reference as though fully set forth herein.

### FIELD OF THE DISCLOSURE

This relates disclosure to multi-user operating systems, in particular, to providing multi-user functionality in single-user operating systems.

### BACKGROUND

An operating system is software code that provides basic functions allowing a user or users to interact with a computer. For example, an operating system provides the user with commands for opening files, closing files, printing files, displaying data objects on a display screen, as well as many other functions.

In typical systems, computers as shipped are configured to interact with a single user. This approach has the drawback of not truly providing multi-user access to a user's files and information, such as documents and photos.

### SUMMARY

When a user accesses a Windows computer and runs one or more applications that display a graphical user interface, the operating system must manage the graphical objects (e.g., windows, icons, images, pens, brushes, etc.) that are used to display the user interface. The module of code that does this is the operating system's graphics subsystem.

This disclosure describes a method for allowing multiple users to independently run graphical applications on a Windows computer at the same time by loading private instances of the graphics subsystem for each user at different virtual addresses within the kernel address space.

### BRIEF DESCRIPTION OF DRAWINGS

FIG. 1 is a diagram of a pair of graphical sessions configured in accordance with this disclosure; and

FIG. 2 is a flowchart of a method for providing multiple users with private access to a computer in accordance with the teachings of this disclosure.

### DETAILED DESCRIPTION

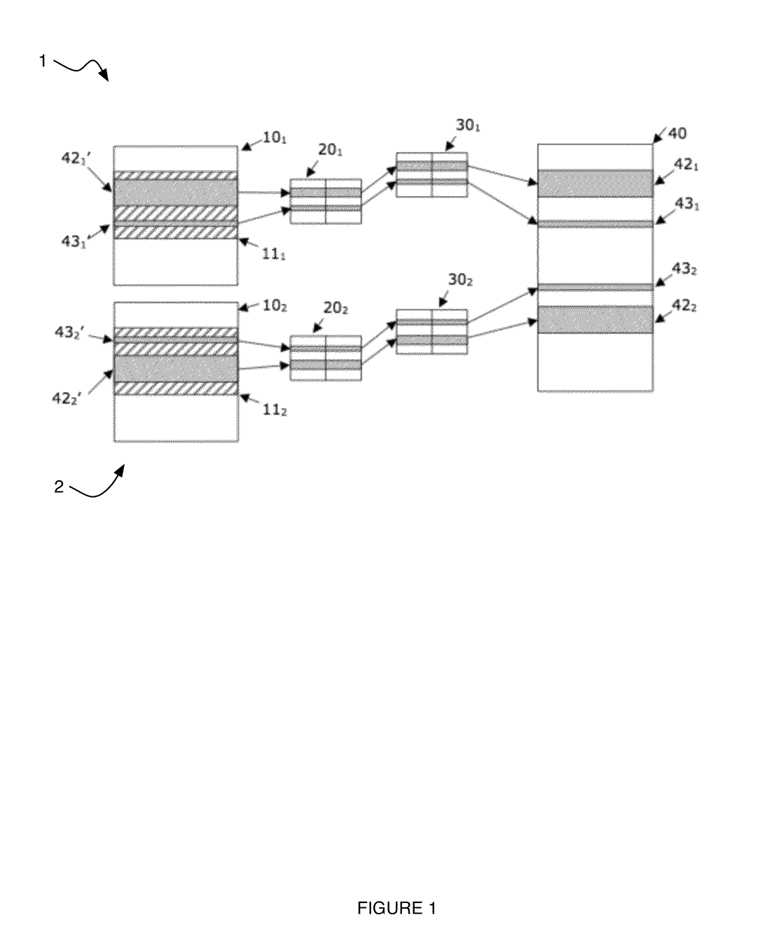

FIG. 1 shows the virtual to physical memory mapping that exists in two processes that are running in different graphical sessions 1, 2. It is contemplated that the graphical session 1, 2 may be operable on a personal computer running, for example, WINDOWS XP or Windows Vista™, operating systems produced and sold by Microsoft Corporation of Redmond, Wash.

As used herein, kernel space refers to the region of virtual addresses that application (user mode) code is not allowed to access. On 32-bit Windows computers, this range is generally 0×8000000 to ×FFFFFFFF.

A graphical session refers to one or more processes that share an instantiation of the operating system's graphics subsystem, including its code and associated data. A graphical session is created for each user/terminal that connects to the computer and runs applications that require the graphics subsystem.

A session space refers to a range of virtual addresses within the kernel space that is the same in all processes, but whose addresses reference physical memory that can only be accessed by processes belonging to the same graphical session.

It is contemplated that the graphical sessions of FIG. 1 may be configured as detailed in U.S. Pat. No. 6,023,749 to Richardson, entitled “Object and method for providing efficient multi-user access to shared operating system kernal code using instancing”, issued Feb. 8, 2000, which is incorporated by reference as though fully set forth herein.

Within each process's kernel space 10₁, 10₂ a session space 11₁, 11₂ is reserved for data that is private to the process's graphical session. Instantiations of the operating system's graphics subsystem code 42₁, 42₂ and its associated data 43₁, 43₂, are stored in physical memory 40 and mapped into the process's respective session spaces 11₁, 11₂ using page directories 20₁, 20₂ and page tables 30₁, 30₂.

In contrast to the prior art, the virtual addresses of graphics subsystem code 42_{1″}, 42_{2″}and data 43_{1″, 43}_{2″}are different in graphical session 1 and graphical session 2. In accordance with yet another embodiment of this disclosure, the system may map allocated physical memory to any address within the session space, limited only by the resolution of the page table. In the example of FIG. 1, instances of the graphics subsystem are allocated at different addresses within the session space range of virtual addresses. It is to be understood that instances of the graphics subsystem may be stored in any region of physical memory.

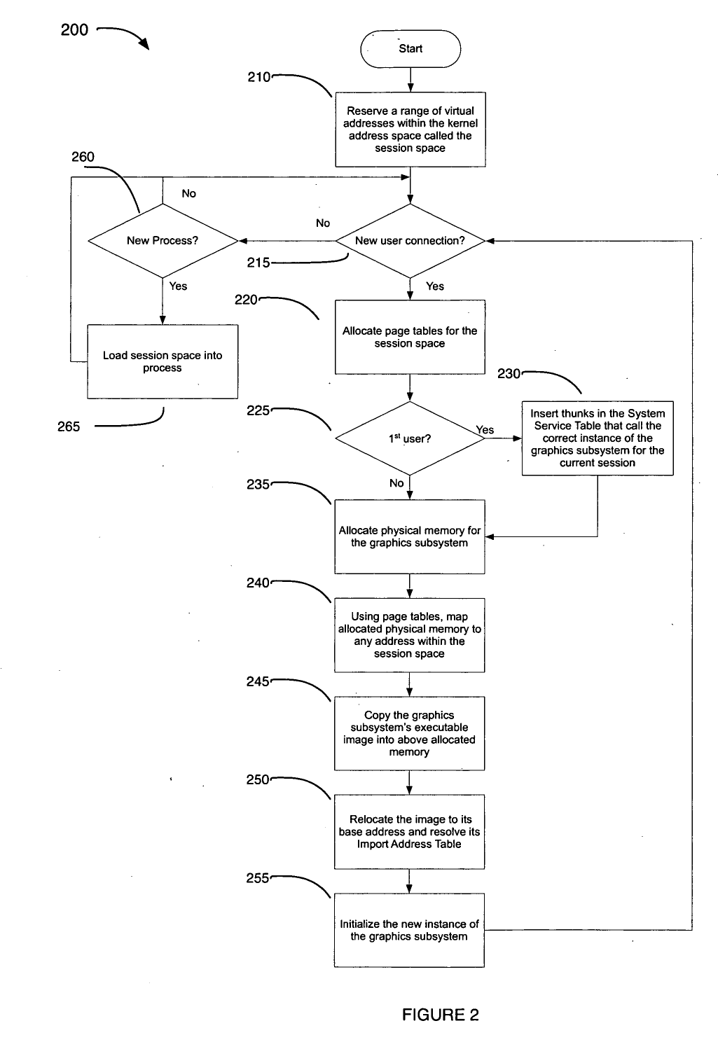

Referring now to FIG. 2, a flowchart of one embodiment of a method 200 for providing multiple users with private access to a computer is shown.

The process of FIG. 2 begins in act 210, where the system reserves a range of virtual addresses within the kernel address space, hereinafter referred to as the session space.

The process moves to query 215, where the system waits for a new user connection. When a new user connection is detected, the system allocates the page table for the session space.

The process then moves to query 220, where it is determined whether this is first user connection. If it is, the process moves to act 230, where thunks are inserted in the system service table that find the correct function address for the current session and jump to it.

The process then moves to act 235, where physical memory is allocated for the graphics subsystem. In act 240, the allocated physical memory is mapped to any address within the session space, limited only by the resolution of the page table.

The process then moves to act 245, where the graphics subsystem's executable image is copied into the allocated memory. In act 250, the image is relocated to its base address and its import address table is resolved. The new instance of the graphics subsystem is then initialized in act 255.

The process then waits for another user connection or a process to start in queries 215 and 260 respectively. If a new process starts, the process moves to act 265 and the session space is loaded into the process.

The process then returns to query 215.

While embodiments and applications of this invention have been shown and described, it will now be apparent to those skilled in the art having the benefit of this disclosure that many more modifications than mentioned above are possible without departing from the inventive concepts disclosed herein.

1. A method for providing multiple users with private access to a computer with an operating system having a graphics subsystem and a range of virtual memory addresses, called the kernel space, for storing protected code, comprising:
reserving a range of virtual memory addresses within the kernel space called the session space;
responsive to a first user connecting to the system:
allocating a page table for mapping virtual memory addresses within the session space range to addresses in physical memory that are private for the first user;
creating an instantiation of the graphics subsystem in physical memory and mapping it, via said page table, to a virtual address within the session space; and
responsive to a second user connecting to said system:
allocating a page table for mapping virtual memory addresses within the session space range to addresses in physical memory that are private for the second user;
creating an instantiation of the graphics subsystem in physical memory and mapping it, via said page table, to a virtual address within the session space that is different than the virtual address of the first user's instantiation of the graphics subsystem.
